(19) United States
(12) Patent Application Publication
(10) Pub. No.: US 2025/0260438 A1
(43) Pub. Date: Aug. 14, 2025

(54) ASSET ACCESS TAG AND USES THEREOF

(71) Applicant: Dell Products L.P., Round Rock, TX (US)

(72) Inventors: Padmanabhan Narayanan, Chennai (IN); Neal Beard, Austin, TX (US); Shree Rathinasamy, Round Rock, TX (US)

(21) Appl. No.: 18/436,444

(22) Filed: Feb. 8, 2024

(51) Int. Cl. H04B 5/70; H04B 5/43

(52) U.S. Cl. CPC H04B 5/70; H04B 5/43

(57) ABSTRACT

Methods, apparatus, and processor-readable storage media for asset access tags and uses thereof are provided herein. An example apparatus includes at least one processing device comprising a processor coupled to a memory; and at least one antenna coupled to the at least one processing device; the at least one processing device being configured: to obtain data, from a network switch, related to one or more aspects of the network switch; to store at least a portion of the obtained data using at least a portion of the memory; and to output, in conjunction with the at least one antenna, the at least a portion of the obtained data to one or more user devices.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Network switches commonly support ports to provide users with connectivity and network operating system options. Many network operating systems can provide guides to retrieve information pertaining, for example, to system electrically erasable programmable read-only memory (EEPROM), installed firmware, inventory status, network operating system status, baseboard management controller (BMC) status, diagnostics reports, etc. While such information may be retrieved in conventional approaches via user and/or command-line interface (CLI) queries, such approaches typically require login access to a networking switch that is live and/or powered on.

Accordingly, many such conventional approaches need support technicians to be physically present at the given site to attempt to access such information. Further, in situations wherein the network switch is in transit and/or contains restrictions in login access, such conventional approaches are typically unable to access the information, regardless of physical presence. Consequently, such conventional approaches are limited by their resource-intensive nature and/or are ineffective at maintaining network switches due to common situational variables.

### SUMMARY

Illustrative embodiments of the disclosure provide asset access tags and uses thereof.

An exemplary apparatus includes at least one processing device including a processor coupled to a memory, and at least one antenna coupled to the at least one processing device. The at least one processing device is configured to obtain data, from a network switch, related to one or more aspects of the network switch, to store at least a portion of the obtained data using at least a portion of the memory, and to output, in conjunction with the at least one antenna, the at least a portion of the obtained data to one or more user devices.

An exemplary computer-implemented method includes establishing a wireless connection with at least one asset access tag associated with at least one network switch, processing data received via the wireless connection with the at least one asset access tag and derived from the at least one network switch, and initiating one or more automated actions, with respect to the at least one network switch, based at least in part on the data received via the wireless connection with the at least one asset access tag.

Illustrative embodiments can provide significant advantages relative to conventional approaches. For example, problems associated with ineffectiveness related to login access and/or networking switch power are overcome in one or more embodiments through implementing an asset access tag configured for use with network switches regardless of network switch power status or login restrictions.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for implementing an asset access tag in connection with a network switch in an illustrative embodiment.

FIG. 2 shows a network switch supporting an asset access tag in an illustrative embodiment.

FIG. 3 shows an example workflow for accessing asset access tag information using an associated user device application in an illustrative embodiment.

FIG. 4 is a flow diagram of a process for implementing an asset access tag in connection with a network switch in an illustrative embodiment.

FIGS. 5 and 6 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

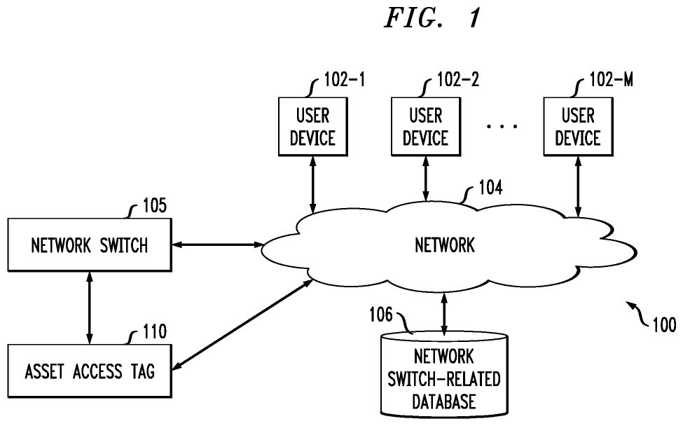

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is network switch 105 and asset access tag 110. As used herein, a network switch refers to a hardware device which includes at least one processor coupled to a memory, configured at least in part to create and/or contribute to a computer network. By way of example, in at least one embodiment, a network switch can include at least one processor, coupled to a memory, running at least one network operating system (NOS), and two or more network ports capable of connecting one or more other hardware devices (e.g., computers, laptops, storage devices, other network switches, etc.) to create a computer network wherein the NOS may help in switching data between different ports in the form of packets (e.g., using Layer 2 and/or Layer 3 networking protocols).

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, one or more of the user devices 102 can have an associated network switch-related database 106 configured to store data pertaining to one or more network switches (e.g., network switch 105), which comprise, for example, system data, firmware data, inventory data, NOS data, BMC data, technician-related data, etc.

The network switch-related database 106 in the present embodiment is implemented using one or more storage systems associated with user devices and/or network switch 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with one or more of the user devices 102, network switch 105 and/or asset access tag 110 are one or more input-output devices, which illustratively comprise keyboards, displays or other types of input-output devices in any combination. Such input-output devices can be used, for example, to support one or more user interfaces to user devices 102, network switch 105 and/or asset access tag 110, as well as to support communication between user devices 102, network switch 105 and/or asset access tag 110 and other related systems and devices not explicitly shown.

Each user device 102, network switch 105 and asset access tag 110 in the FIG. 1 embodiment is assumed to be implemented using at least one processing device. Each such processing device generally comprises at least one processor and an associated memory, and implements one or more functional modules for controlling certain features of the user devices 102, network switch 105 and asset access tag 110.

More particularly, user devices 102, network switch 105 and asset access tag 110 in this embodiment each can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows user devices 102, network switch 105 and asset access tag 110 to communicate over the network 104 with the user devices 102, and illustratively comprises one or more conventional transceivers.

It is to be understood that the particular set of elements shown in FIG. 1 for implementing asset access tag 110 in connection with network switch 105 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, user devices 102 and network switch-related database 106 can be on and/or part of the same processing platform.

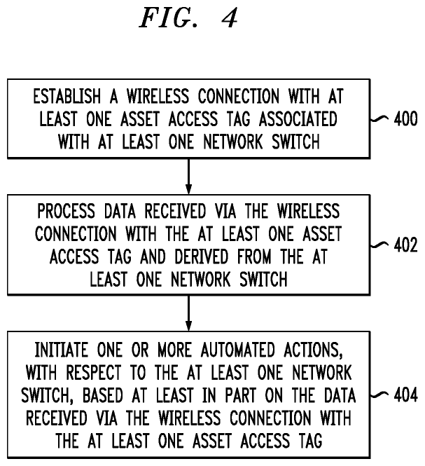

An exemplary process utilizing user devices 102, network switch 105 and asset access tag 110 in computer network 100 will be described in more detail with reference to the flow diagram of FIG. 4.

Accordingly, at least one embodiment includes generating and/or implementing asset access tags in connection with network switches. As used in the context of one or more embodiments, a data center or information technology infrastructure can include a number of inventory controlled items such as, e.g., servers, network switches, storage components, racks, power distribution units, patch panels, optics, cables, etc., and each of these items can be referred to herein as an example of an asset. Also, as used herein, a tag refers to an item of hardware (e.g., a card-like structure which can be enclosed (e.g., in a plastic cover)) that can be physically connected to at least one asset and which can provide, when connected, information about the asset (e.g., asset manufacturing details, asset capabilities, asset ownership, etc.).

As detailed herein, such an embodiment includes enabling the ability to retrieve network switch maintenance-related information such as information pertaining, e.g., to system EEPROM, installed firmware, inventory status, network operating system status, BMC status, diagnostics reports, etc., provides fine-grained visibility into the given network switch's tracking, status, and/or history, reduces time and resource expenditures, and improves productivity related to network switch maintenance and/or management.

As such, one or more embodiments include generating and/or implementing at least one reusable asset access tag (e.g., a near-field communication-based (NFC-based) asset access tag) and an associated software application (e.g., a mobile device application, a desktop computer application, etc.) to facilitate visibility and control (e.g., increased visibility and control) for network switches. While at least one embodiment includes the implementation of an NFC EEPROM integrated circuit (IC), one or more other embodiments may include the implementation of an NFC SSD IC (e.g., an NFC SSD IC implemented over a serial peripheral interface (SPI) bus using an SPI multiplexer). In either type of embodiment, an NFC asset tag is used to store platform-specific data (e.g., hardware data, software data, and/or firmware data) for efficient retrieval from a network switch unit (e.g., un-racked unit, an offline unit, and/or an in-transit unit) without the need for a user to login to one or more user-specific and/or organizational-specific portals.

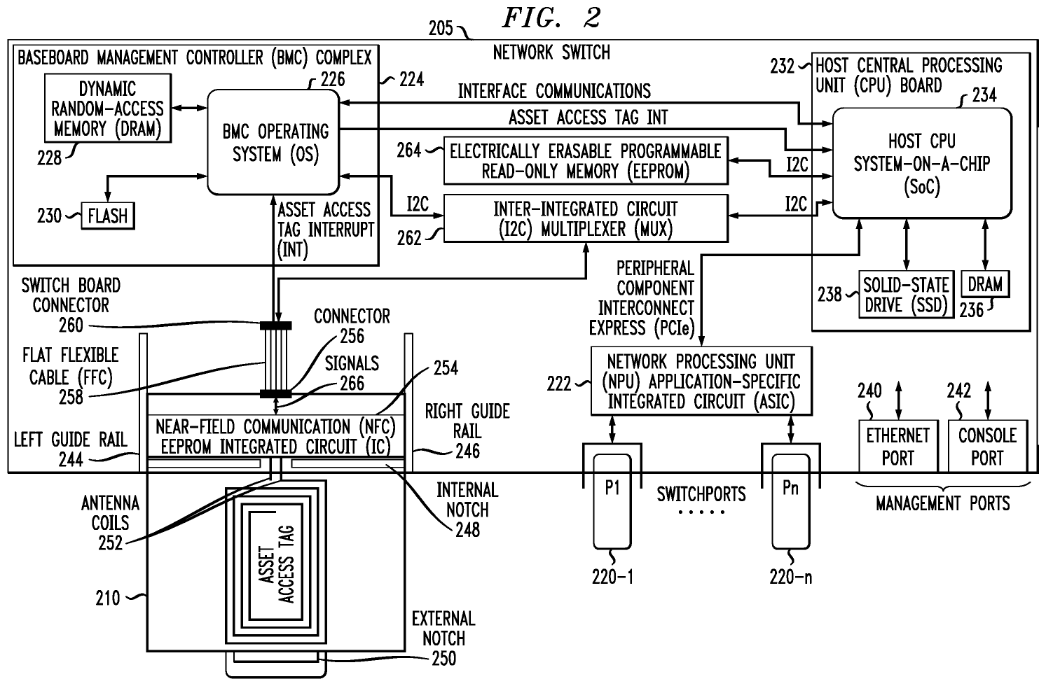

FIG. 2 shows a network switch 205 supporting an asset access tag 210 in an illustrative embodiment. By way of illustration, network switch 205 includes switchport 220-1 (p₁) through switchport 220-n (pₙ), a network processing unit (NPU) application-specific integrated circuit (ASIC) 222 that is connected to the host CPU system-on-a-chip (SoC) 234 (also referred to herein as the NOS) over a peripheral component interconnect express (PCIe) link, a BMC complex 224 (which includes a dynamic random-access memory (DRAM) component 228 and a flash memory component 230) and a host CPU board 232 (which includes a DRAM component 236 and an SSD component 238) along with out-of-band management (OOBM) ports (e.g., registered jack (RJ) 45 ports) including an Ethernet port 240 and a console port 242. The BMC operating system (OS) 226, running in the BMC complex 224, and the host CPU SoC 234, running in the host CPU board 232, may communicate using a variety of interfaces such as, for example, SPI, inter-integrated circuit (I2C), server message block (SMB), PCIe, universal serial bus (USB), local inter-process communication (LPC), general purpose input-output (GPIO), etc. Additionally, BMC OS 226 can relay any interrupt (INT) received from the asset access tag 210 to the host CPU SoC 234 using a dedicated interrupt line.

Further, as illustrated in FIG. 2, the DRAM component 236 and the SSD component 238 attached to the host CPU SoC 234 provide the primary and secondary memory for the host CPU SoC 234. Also, in one or more embodiments (e.g., in connection with network switches that support intelligent platform management interface (IPMI)), the DRAM component 228 and flash memory component 230 connected to the BMC complex 224 provide the primary and secondary memory for the BMC OS 226 (e.g., which can provide the IPMI functionality).

Additionally, as further described herein, one or more embodiments include modifying and/or redesigning a network switch (such as, e.g., network switch 205) to support asset access tag 210 (e.g., a plastic covered asset tag which does not contain printed details). Such modifications and/or design changes can include, for example, implementing a left guide rail 244 and a right guide rail 246, located inside of the chassis of the network switch 205. Asset access tag 210 can be inserted and/or positioned between guide rails 244 and 246, wherein an internal notch 248 and an external notch 250 on the asset access tag 210 prevent the asset access tag 210 from being inadvertently pulled out completely or recessed flush into the chassis of the network switch 205.

Additionally, the portion and/or region of the asset access tag 210 which protrudes outside of the chassis of the network switch 205 (when inserted into the network switch 205 between guide rails 244 and 246) houses NFC antenna coils 252 that are connected to an NFC EEPROM IC 254. As also depicted in FIG. 2, the asset access tag connector 256 can provides signals 266 including, e.g., voltage common collector (Vcc), ground (GND), serial data line (SDA), serial clock line (SCL), (which are I2C signals), and INT. The NFC EEPROM IC 254 (also referred to herein simply as NFC IC) can include, in one or more embodiments, a dynamic NFC tag IC wherein the system EEPROM 264 contents of the network switch may be accessed either via NFC or through I2C. Additionally, in one or more embodiments, system EEPROM 264 is the source of information to the “System” section contained in the NFC EEPROM IC 254. Also, in such an embodiment, the contents of the system EEPROM 264 can be copied to the “System” section of NFC EEPROM IC 254 at startup of the network switch 205.

In an example embodiment such as depicted in FIG. 2, the NFC EEPROM IC 254 interfaces, via asset access tag connector 256 on the asset access tag 210, to network switch board connector 260 over a flat flexible cable (FFC) 258 that can, e.g., interface the NFC IC's I2C to an I2C multiplexer (MUX) 262 on the network switch 205 such that the BMC complex 224 running a BMC OS 226, or the host CPU SoC 234 (on the host CPU board 232) running a BIOS, a diagnostics OS, and/or a network operating system may arbitrate for I2C access to the NFC EEPROM IC 254. By way of illustration, NFC EEPROM ICs (such as, e.g., NFC EEPROM IC 254) have I2C access over a single I2C interface (which can include SDA and SCL signals). Accordingly, in such an embodiment, the contents of various sections of the NFC EEPROM IC 254 can be read or written to by software on the BMC complex 224 (e.g., the BMC OS 226) or the host CPU board 232 (e.g., the host CPU SoC 234). In order to support access from both the BMC OS 226 and the host CPU SoC 234, an I2C MUX 262 with arbitration logic may be used such that the I2C MUX 262 serializes access to the NFC EEPROM IC 254 when both the BMC OS 226 and the host CPU SoC 234 attempt to access the NFC EEPROM IC 254.

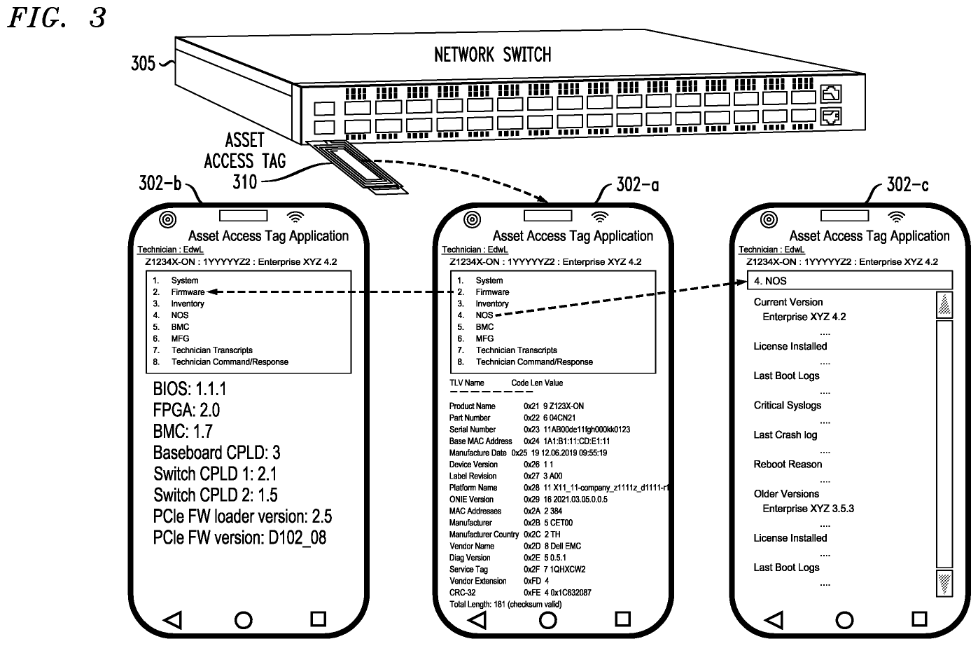

In one or more example use case scenarios, the BMC OS 226 and the host CPU SoC 234 write a variety of useful information to various sections of the NFC EEPROM IC 254 over the I2C MUX 262 link. An end user, using a device (such as, e.g., user device 102 in FIG. 1 and/or user device 302 in FIG. 3) with NFC reader capability can retrieve various section information from the NFC EEPROM IC 254 via the NFC antenna coils 252 of the asset access tag 210. In some instances, the end user, using a device (such as, e.g., user device 102 or user device 302) with NFC reader capability, can also write specific commands to one or more specific sections of the NFC EEPROM IC 254. In such an embodiment, when the end user writes commands to specific sections of the NFC EEPROM IC 254, the NFC EEPROM IC 254 generates an interrupt (indicated as “Asset Access Tag INT” in FIG. 2) to the BMC OS 226, and the BMC OS 226 may process the interrupt and/or relay the interrupt (“Asset Access Tag INT” in FIG. 2) to the host CPU SoC 234 over a dedicated interrupt line, thereby enabling the host CPU SoC 234 to read the command written by the end user (over the I2C link) and to process the command. Additionally, in one or more embodiments, such commands can be accompanied by at least one JavaScript Object Notation (JSON) web token (JWT), which can be used for authentication purposes, such that the host CPU SoC 234 can authenticate the command before executing command.

FIG. 3 shows an example workflow for accessing asset access tag information using an associated user device application in an illustrative embodiment. By way of illustration, a technician can have a software application (e.g., identified as asset access tag application in FIG. 3) associated with asset access tag 310 installed on a user device 302 (e.g., a mobile device such as a smartphone), which has three instances shown in FIG. 3 illustrated as 302-a, 302-b and 302-c, and the software application can be used to retrieve information stored in the EEPROM of the asset access tag 310, wherein at least a portion of such information has been obtained by asset access tag 310 from network switch 305. When the technician, for example, engages and/or opens the software application on the user device 302, the software application is launched and, based on the asset access tag-specific media type and/or multipurpose internet mail extension (MIME) type, the available asset access tag EEPROM sections to be displayed (e.g., system, firmware, inventory, NOS, BMC, manufacturing (MFG), technician transcript, and technician command/response sections) are listed, as illustrated in user device instance 302-a and user device instance 302-b.

More specifically, user device instance 302-a depicts relevant information about network switch 305 being displayed by the software application upon user-selection of the “System” section. The “System” section contains information about the network switch 305 such as, for example, product name, part number, serial number, base media access control (MAC) address, manufacturing date, etc. As also illustrated in FIG. 3, user device instance 302-b depicts relevant information about network switch 305 being displayed by the software application upon user-selection of the firmware section, which can include the firmware version of various components of the network switch 305 including, e.g., BIOS, FPGA, BMC, baseboard complex programmable logic device (CPLD), switch CPLDs, PCIe firmware, etc., and user device instance 302-c depicts relevant information about network switch 305 being displayed by the software application upon user-selection of the NOS section, which can include the current NOS (i.e., host CPU SoC) version, license(s) installed, last boot logs, critical syslogs, etc.

In one or more embodiments, the NFC IC's EEPROM can include multiple specific sections for diverse types of collected data, and examples of when and/or how data from multiple such sections are accessed and/or populated, along with one or more use cases, are described below. With respect to system data, for example, when the network switch gets power cycled, the BMC reads and checks the validity of the system EEPROM checksum on the asset access tag system section, and if the contents are empty or invalid, the BMC copies the contents from the network switch system EEPROM to the asset access tag system section. Such information and/or action can address, for example, open network install environment (ONIE) switch hardware asset tracking and labelling requirements.

By way of further example, with respect to firmware data, upon a power cycle, the BMC reads and updates the firmware section, if necessary, with details of the firmware version along with change history timestamps. Also, with respect to inventory data, the BMC updates the inventory section with details of one or more field replaceable units (FRUs) such as, e.g., one or more power supply units (PSUs), one or more fans, one or more transceivers, etc., as well as one or more non-FRUs such as, e.g., one or more SSDs, one or more DRAMs, etc. Such details can include, for example, serial numbers, part numbers, change history timestamps, etc., and the use of such information can assist, e.g., in tracking replacements, faults and/or change in behavior after un-racking or re-racking, during or after manufacturing services, etc.

Additionally, with respect to network operating system data, a network operating system saves the following upon boot-up: identifying information for current and previous versions, identifying information for licenses installed, boot console logs, reason(s) for previous reboot(s), etc. Also, prior to a reboot and/or shutdown, the network operating system may save the following: critical system logs, crash logs, mini core and/or traceback information, platform environmental monitoring data, etc. Boot logs (e.g., from BIOS, a network operating system early init, etc.) can be specifically useful in scenarios, for example, wherein the user has powered down unresponsive systems and the console logs were not captured (e.g., due to lack of connectivity). More particularly, in scenarios where the NOS/host CPU SoC is unresponsive after power-up, the logs from the BIOS and the NOS/host CPU SoC early initialization may provide information about any failures that may have resulted in the NOS/host CPU SoC becoming unresponsive, thereby facilitating debugging.

With respect to BMC data, the BMC OS may save abnormal sensor readings (e.g., environmental data, power data, voltage data, current data, etc.) along with timestamps. Also, with respect to diagnostics OS data, when run, the diagnostics OS can save diagnostic test summary data. Additionally, technician transcript data can provide the ability for technicians to log maintenance window-related activities as transcripts including observations of faults. Further, with respect to technician command/response data, technicians may update network administrator-generated JWT encapsulated commands such as, for example, shut/no-shut an interface (e.g., while replacing a transceiver), and rebooting/power cycling a unit (e.g., to initiate a firmware upgrade, recover an unresponsive unit or prior to a remote maintenance agent (RMA), etc.).

At least one embodiment can be useful for edge and/or remote data centers wherein a technician may not know in advance when maintenance is to be performed, and/or wherein network administrators who have the ability to login and issue commands may not be online when a technician is about to perform maintenance. In such scenarios, the user's network administrator may be able to issue JWT-encapsulated commands that are valid for a specific duration (e.g., a given number of hours), as can be supported by the representational state transfer (REST) application programming interface (API) authentication infrastructure by one or more network operating systems.

In one or more embodiments, NFC ICs have an interrupt generation mechanism when written to specific command sections. In such an embodiment, the asset access tag INT may be routed to the BMC OS and/or the host CPU network operating system, which can consume the JWT and inject the commands into the network operating system's management interface (CLI, REST, etc.).

In at least one embodiment, information/data such as detailed above with respect to the various sections can be read by a technician using a software application (e.g., on the technician's mobile device) even when the corresponding network switch unit is offline, while also allowing the technician to save maintenance transcripts as well as place JWT-encapsulated commands during maintenance activities.

Accordingly, as detailed herein, one or more embodiments include improving productivity associated with network switches and technicians associated therewith. Further, in contrast to conventional legacy luggage tags that are printed per-network switch, the asset access tags in one or more embodiments are re-useable and may be extended to other devices such as, e.g., servers and storage platforms as well.

FIG. 4 is a flow diagram of a process for implementing an asset access tag in connection with a network switch in an illustrative embodiment. It is to be understood that this particular process is only an example, and additional or alternative processes can be carried out in other embodiments.

In this embodiment, the process includes steps 400 through 404. These steps are assumed to be performed by asset access tag 110 in connection with a software application executing on one or more user devices 102.

Step 400 includes establishing a wireless connection with at least one asset access tag associated with at least one network switch. In at least one embodiment, establishing a wireless connection includes establishing, using one or more NFC techniques, a wireless connection with at least one NFC-based asset access tag engaged with the at least one network switch.

Step 402 includes processing data received via the wireless connection with the at least one asset access tag and derived from the at least one network switch. In one or more embodiments, processing data received via the wireless connection includes displaying, on an interface of the at least one processing device and based at least in part on one or more of a media type associated with the at least one asset access tag and a MIME type associated with the at least one asset access tag, multiple categories of data derived from the at least one network switch.

Step 404 includes initiating one or more automated actions, with respect to the at least one network switch, based at least in part on the data received via the wireless connection with the at least one asset access tag. In at least one embodiment, initiating one or more automated actions includes inputting one or more commands, via the at least one asset access tag using one or more JWTs, to at least one of a BMC OS of the at least one network switch and a host CPU SoC of the at least one network switch. Inputting such commands can also be carried out, for example, in connection with one or more user devices and/or one or more other interfaces.

Accordingly, the particular processing operations and other functionality described in conjunction with the flow diagram of FIG. 4 are presented by way of illustrative example only, and should not be construed as limiting the scope of the disclosure in any way. For example, the ordering of the process steps may be varied in other embodiments, or certain steps may be performed concurrently with one another rather than serially.

Additionally, as detailed herein, one or more embodiments include an apparatus comprising at least one processing device comprising a processor coupled to a memory, and at least one antenna coupled to the at least one processing device. In such an embodiment, the at least one processing device is configured to obtain data, from a network switch, related to one or more aspects of the network switch; to store at least a portion of the obtained data using at least a portion of the memory; and to output, in conjunction with the at least one antenna, the at least a portion of the obtained data to one or more user devices. By way of example, in one or more embodiments, the apparatus comprises an asset access tag configured for use with at least the network switch.

In at least one embodiment, the at least one antenna can include at least one NFC antenna, and the at least one processing device can include at least one EEPROM IC (e.g., at least one NFC EEPROM IC). Additionally or alternatively, the at least one processing device comprises at least one SSD IC such as, e.g., at least one NFC SSD IC implemented over at least one SPI bus using at least one SPI multiplexer.

In one or more embodiments, obtaining data from a network switch can include accessing at least a portion of the data from the network switch using at least one of NFC and at least one I2C. Additionally or alternatively, obtaining data from a network switch can include interfacing, using at least one connector, to at least one network switch board connector over at least one FFC. In such an embodiment, interfacing can include accessing data associated with at least one of a BMC OS of the network switch and a host CPU SoC of the network switch. Also, in at least one embodiment, obtaining data from a network switch can include obtaining data associated with one or more of network switch system EEPROM, firmware installed on the network switch, inventory status of one or more elements of the network switch, network operating system status, BMC status, and one or more diagnostics reports.

Further, in one or more embodiments, storing at least a portion of the obtained data includes storing the at least a portion of the obtained data across multiple data type-specific sections within the memory. Additionally, in at least one embodiment the at least one processing device can be further configured to provide one or more commands, via at least one network operating system interface of the network switch using one or more JWTs, to at least one of a BMC OS of the network switch and a host CPU SoC of the network switch.

The above-described illustrative embodiments provide significant advantages relative to conventional approaches. For example, some embodiments are configured to implement an asset access tag configured for consistent use in connection with various network switches regardless of power status or login restrictions. These and other embodiments can effectively overcome problems associated with ineffectiveness related to login access and/or networking switch power.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

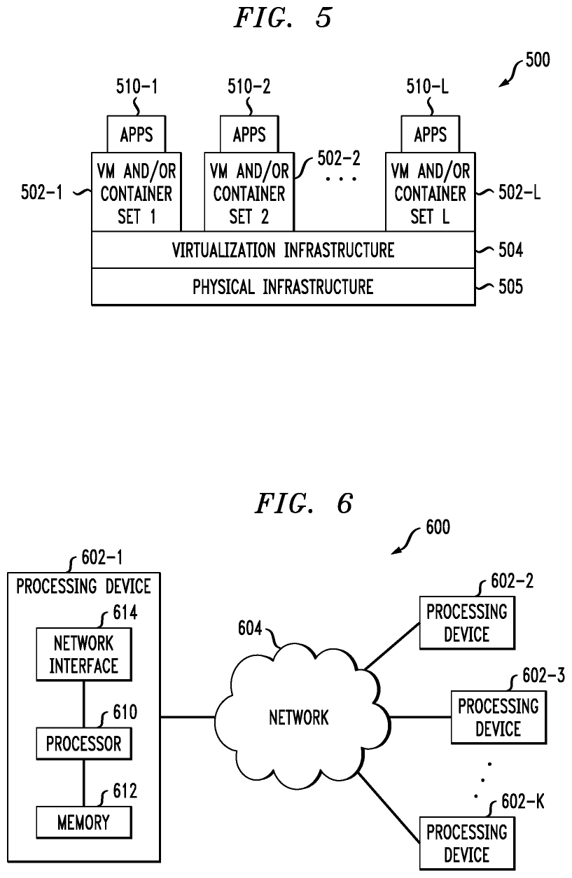

Illustrative embodiments of processing platforms will now be described in greater detail with reference to FIGS. 5 and 6. Although described in the context of system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that are utilized to implement at least a portion of the information processing system 100. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 comprise respective VMs, respective sets of one or more containers, or respective sets of one or more containers running in VMs. In some implementations of the FIG. 5 embodiment, the VMs/container sets 502 comprise respective VMs implemented using virtualization infrastructure 504 that comprises at least one hypervisor.

A hypervisor platform may be used to implement a hypervisor within the virtualization infrastructure 504, wherein the hypervisor platform has an associated virtual infrastructure management system. The underlying physical machines comprise one or more information processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of system 100 and includes a plurality of processing devices, denoted 602-1, 602-2, 602-3, . . . 602-K, which communicate with one another over a network 604.

The network 604 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 602-1 in the processing platform 600 comprises a processor 610 coupled to a memory 612.

The processor 610 comprises a microprocessor, a CPU, a GPU, a TPU, a microcontroller, an ASIC, a FPGA or other type of processing circuitry, as well as portions or combinations of such circuitry elements.

The memory 612 comprises random access memory (RAM), read-only memory (ROM) or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used.

Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
at least one antenna coupled to the at least one processing device;
the at least one processing device being configured:
to obtain data, from a network switch, related to one or more aspects of the network switch;
to store at least a portion of the obtained data using at least a portion of the memory; and
to output, in conjunction with the at least one antenna, the at least a portion of the obtained data to one or more user devices.

2. The apparatus of claim 1, wherein the at least one antenna comprises at least one near-field communication (NFC) antenna.

3. The apparatus of claim 1, wherein the at least one processing device comprises at least one electrically erasable programmable read-only memory (EEPROM) integrated circuit (IC).

4. The apparatus of claim 3, wherein the at least one EEPROM IC comprises at least one NFC EEPROM IC.

5. The apparatus of claim 1, wherein the at least one processing device comprises at least one solid-state drive (SSD) IC.

6. The apparatus of claim 5, wherein the at least one SSD IC comprises at least one NFC SSD IC implemented over at least one serial peripheral interface (SPI) bus using at least one SPI multiplexer.

7. The apparatus of claim 1, wherein obtaining data from a network switch comprises accessing at least a portion of the data from the network switch using at least one of NFC and at least one inter-integrated circuit (I2C).

8. The apparatus of claim 1, wherein obtaining data from a network switch comprises interfacing, using at least one connector, to at least one network switch board connector over at least one flat flexible cable (FFC).

9. The apparatus of claim 8, wherein interfacing comprises accessing data associated with at least one of a baseboard management controller (BMC) operating system (OS) of the network switch and a host central processing unit (CPU) system-on-a-chip (SoC) of the network switch.

10. The apparatus of claim 1, wherein obtaining data from a network switch comprises obtaining data associated with one or more of network switch system EEPROM, firmware installed on the network switch, inventory status of one or more elements of the network switch, network operating system status, BMC status, and one or more diagnostics reports.

11. The apparatus of claim 1, wherein the apparatus comprises an asset access tag configured for use with at least the network switch.

12. The apparatus of claim 1, wherein the at least one processing device is further configured:
to provide one or more commands, via at least one network operating system interface of the network switch using one or more JavaScript Object Notation (JSON) web tokens (JWTs), to at least one of a BMC OS of the network switch and a host CPU SoC of the network switch.

13. A computer-implemented method comprising:
establishing a wireless connection with at least one asset access tag associated with at least one network switch;
processing data received via the wireless connection with the at least one asset access tag and derived from the at least one network switch; and
initiating one or more automated actions, with respect to the at least one network switch, based at least in part on the data received via the wireless connection with the at least one asset access tag;
wherein the method is performed by at least one processing device comprising a processor coupled to a memory.

14. The computer-implemented method of claim 13, wherein initiating one or more automated actions comprises inputting one or more commands, via the at least one asset access tag using one or more JavaScript Object Notation (JSON) web tokens (JWTs), to at least one of a baseboard management controller (BMC) operating system (OS) of the at least one network switch and a host central processing unit (CPU) system-on-a-chip (SoC) of the at least one network switch.

15. The computer-implemented method of claim 13, wherein establishing a wireless connection comprises establishing, using one or more near-field communication (NFC) techniques, a wireless connection with at least one NFC-based asset access tag engaged with the at least one network switch.

16. The computer-implemented method of claim 13, wherein processing data received via the wireless connection comprises displaying, on an interface of the at least one processing device and based at least in part on one or more of a media type associated with the at least one asset access tag and a multipurpose internet mail extension (MIME) type associated with the at least one asset access tag, multiple categories of data derived from the at least one network switch.

17. A non-transitory processor-readable storage medium having stored therein program code of one or more software programs, wherein the program code when executed by at least one processing device causes the at least one processing device:
to establish a wireless connection with at least one asset access tag associated with at least one network switch;
to process data received via the wireless connection with the at least one asset access tag and derived from the at least one network switch; and
to initiate one or more automated actions, with respect to the at least one network switch, based at least in part on the data received via the wireless connection with the at least one asset access tag.

18. The non-transitory processor-readable storage medium of claim 17, wherein initiating one or more automated actions comprises inputting one or more commands, via the at least one asset access tag using one or more JavaScript Object Notation (JSON) web tokens (JWTs), to at least one of a baseboard management controller (BMC) operating system (OS) of the at least one network switch and a host central processing unit (CPU) system-on-a-chip (SoC) of the at least one network switch.

19. The non-transitory processor-readable storage medium of claim 17, wherein establishing a wireless connection comprises establishing, using one or more near-field communication (NFC) techniques, a wireless connection with at least one NFC-based asset access tag engaged with the at least one network switch.

20. The non-transitory processor-readable storage medium of claim 17, wherein processing data received via the wireless connection comprises displaying, on an interface of the at least one processing device and based at least in part on one or more of a media type associated with the at least one asset access tag and a multipurpose internet mail extension (MIME) type associated with the at least one asset access tag, multiple categories of data derived from the at least one network switch.
